(19) United States
(12) Patent Application Publication
(10) Pub. No.: US 2004/0110878 A1
(43) Pub. Date: Jun. 10, 2004

(54) Flame-retardant thermoset compositions

(75) Inventors: Susanne Knop, Huerth (DE); Martin Sicken, Koeln (DE); Sebastian Hoerold, Diedorf (DE)

Correspondence Address: CLARIANT CORPORATION, INTELLECTUAL PROPERTY DEPARTMENT, 4000 MONROE ROAD, CHARLOTTE, NC, 28205, US

(73) Assignee: Clariant GmbH

(21) Appl. No.: 10/669,483

(22) Filed: Sep. 24, 2003

(30) Foreign Application Priority Data
Sep. 25, 2002 (DE) 10244578.8

(51) Int. Cl. C08K 5/49

(52) U.S. Cl. 524/115

(57) ABSTRACT

The invention relates to flame-retardant thermoset compositions which comprise, as flame retardant, at least one phosphinic salt of the formula (I) and/or a diphosphinic salt of the formula (II) and/or polymers of these

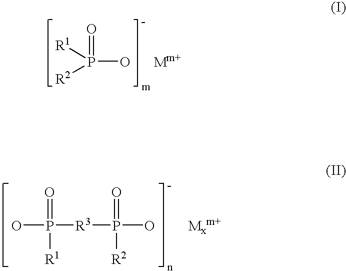

where

R¹,R² are identical or different and are C₁-C₆-alkyl, linear or branched, and/or aryl;

R³ is C₁-C₁₀-alkylene, linear or branched, C₆-C₁₀-arylene, -alkylarylene or -arylalkylene;

M is Mg, Ca, Al, Sb, Sn, Ge, Ti, Zn, Fe, Zr, Ce, Bi, Sr, Mn, Li, Na, K and/or a protonated nitrogen base;

m is from 1 to 4;

n is from 1 to 4; and

x is from 1 to 4,

and also comprise at least one synergistic component from the group consisting of organic or inorganic phosphorus compounds.

The invention further relates to a process for preparing these flame-retardant thermoset compositions and to their use.

The invention relates to flame-retardant thermoset compositions, to a process for their preparation, and to their use.

Components made from thermoset resins, in particular those which have glass-fiber reinforcement, feature good mechanical properties, low density, substantial chemical resistance and excellent surface quality. This and their low cost has led to their increasing use as replacements for metallic materials in the application sectors of rail vehicles, the construction of buildings and air travel.

Unsaturated polyester resins (UP resins), epoxy resins (EP resins) and polyurethanes (PU resins) are combustible and therefore need flame retardants in some applications. Increasing demands in the market for fire protection and for environmental compatibility in products are increasing interest in halogen-free flame retardants, for example in phosphorus compounds or metal hydroxides.

Depending on the application sector, there are different requirements in relation to mechanical, electrical and fire-protection properties. In the rail vehicle sector in particular, fire-protection requirements have recently been made more stringent.

It is known that bromine- or chlorine-containing acid and/or alcohol components are used to formulate flame-retardant unsaturated polyester resins. Examples of these components are hexachloroendomethylene tetrahydrophthalic acid (HET acid), tetrabromophthalic acid and dibromoneopentyl glycol. Antimony trioxide is often used as a synergist.

In JP-05 245 838 (CA 1993: 672700), aluminum hydroxide, red phosphorus and antimony trioxide are combined with a brominated resin to improve flame retardancy. A disadvantage of bromine- and chlorine-containing resins is that corrosive gases are produced in a fire, and this can result in considerable damage to electronic components, for example to relays in rail vehicles. Unfavorable conditions can also lead to the formation of polychlorinated or brominated dibenzodioxins and furans. There is therefore a requirement for unsaturated polyester resins and unsaturated polyester molding compositions which are flame-retardant and halogen-free.

It is known that unsaturated polyester resins and unsaturated polyester molding compositions may be provided with fillers, such as aluminum hydroxide. The elimination of water from aluminum hydroxide at elevated temperatures gives some degree of flame retardancy. At filler levels of from 150 to 200 parts of aluminum hydroxide per 100 parts of UP resin it is possible to achieve self-extinguishing properties and low smoke density. A disadvantage of systems of this type is their high specific gravity, and attempts are made to reduce this by adding, for example, hollow glass beads [Staufer, G., Sperl, M., Begemann, M., Buhl, D., Düll-Mühlbach, I., Kunststoffe 85 (1995), 4].

PL 159 350 (CA 1995: 240054) describes laminates made from unsaturated polyester resins with up to 180 parts of magnesium hydroxide. However, injection processes, which are extremely important industrially, cannot be used with formulations of this type, due to the high viscosity of the uncured UP resin with the aluminum hydroxide or, respectively, magnesium hydroxide.

The processes described at a later stage below for formulating flame-retardant unsaturated polyester resins likewise have a large number of disadvantages, in particular the requirement for a very high filler content.

To reduce the total filler content, aluminum hydroxide can be combined with ammonium polyphosphate, as described in DE-A-37 28 629. JP 57016017 (CA96(22): 182248) describes the use of red phosphorus as a flame retardant for unsaturated polyester resins, and JP-55 094 918 (CA93(24): 22152t) describes the combination of aluminum hydroxide, red phosphorus and antimony trioxide.

PL 161 333 (CA 1994: 632278) achieves low smoke density and low-toxicity decomposition products by using aluminum hydroxide, magnesium hydroxide or basic magnesium carbonate, red phosphorus and, if desired, finely dispersed silica. DE-A-21 59 757 moreover claims the use of melamine and aluminum hydroxide.

Since aluminum hydroxide on its own is not a very effective flame retardant for unsaturated polyester resins or for epoxy resins, combinations with red phosphorus are also proposed, in order to reduce the filler content. A disadvantage here, however, is the red intrinsic color of the product, limiting its use to components with dark pigmentation.

Unsaturated polyester resins are solutions, in copolymerizable monomers, preferably styrene or methyl methacrylate, of polycondensation products made from saturated and unsaturated dicarboxylic acids, or from anhydrides of these, together with diols. UP resins are cured by free-radical polymerization using initiators (e.g. peroxides) and accelerators. The double bonds in the polyester chain react with the double bond in the copolymerizable solvent monomer.

The most important dicarboxylic acids for preparing the polyesters are maleic anhydride, fumaric acid and terephthalic acid. The diol most frequently used is 1,2-propanediol. Use is also made of ethylene glycol, diethylene glycol and neopentyl glycol, inter alia. The most suitable crosslinking monomer is styrene. Styrene is fully miscible with the resins and copolymerizes readily. The styrene content in unsaturated polyester resins is normally from 25 to 40%. A monomer which can be used instead of styrene is methyl methacrylate.

Unsaturated polyester resins differ in their chemical and physical properties and in their fire behavior significantly from the similarly named polyesters, which, however, in contrast to the aforementioned unsaturated polyester resins, are thermoplastic polymers. These polyesters are also prepared by completely different processes than those as described in the preceding paragraph for the unsaturated polyester resins. Polyesters can be prepared, for example, by ring-opening polymerization of lactones or by polycondensation of hydroxycarboxylic acids, in which case polymers of the general formula —[O—R—(CO)]— are obtained. The polycondensation of diols and dicarboxylic acids and/or derivatives of dicarboxylic acids produces polymers of the general formula —[O—R¹—O—(CO)—R²—(CO)]—. Branched and crosslinked polyesters can be obtained by polycondensation of alcohols having a functionality of three or more with polyfunctional carboxylic acids.

Unsaturated polyester resins and polyesters are therefore two completely different polymers and represent completely different polymer groups.

Another group of thermosets, epoxy resins, are nowadays used for preparing molding compositions and coatings wa very high filler thermal, mechanical and electronic properties.

Epoxy resins are compounds prepared by a polyoxide can be combined epoxy resin component with a crosslinking (har DE-A-37 28 629. JP epoxy resin components used are aromatic polye of red phosphorus as bisphenol A diglycidyl ester, bisphenol F diglycides, and JP-55 094 918 esters of phenol-formaldehyde resins or cresol-of aluminum hydroxide, polyglycidyl esters of phthalic, isophthalic or tert trimellitic acid, N-glycidyl compounds of aromatic heterocyclic nitrogen bases, or else di- or polyghoke density and low-polyhydric aliphatic alcohols. Hardeners which um hydroxide, polyamines, such as triethylene tetramine, aminonate, red phosphorus isophoronediamine, polyamidoamines, polybasic59 757 moreover claims these, e.g. phthalic anhydride, hexahydrophthal methyltetrahydrophthalic anhydride, or phenols. also take place via polymerization using suitablery effective flame epoxy resins,

Epoxy resins are suitable for the potting of electosed, in order to reduce components, and for saturation and impregnation, is the red intrinsic resins used in electrical engineering are predomits with dark and used for printed circuit boards or insulators.

In the prior art, epoxy resins for printed circuit bopolymerizable rendered flame-retardant by including bromine-acrylate, of compounds in the reaction, in particular tetrabrode and unsaturated disadvantage is that brominated hydrocarbon (altogether with diols. UP is liberated in a fire, and this can cause corrosiosing initiators (e.g. unfavorable conditions, polybrominated dibenzoin the polyester chain also be produced. The use of aluminum hydroxile solvent monomer. excluded since it eliminates water when processed.

Fire-protection requirements for electrical and electronic equipment are laid down in specifications and standards for product safety. In the US, fire-protection testing and approval procedures are carried out by Underwriters Laboratories (UL), and UL specifications are nowadays accepted worldwide. The fire tests for plastics were developed in order to determine the resistance of the materials to ignition and flame spread.

The materials have to pass horizontal burning tests (Classification UL 94HB) or the more stringent vertical tests (UL 94V-2, V-1 or V-0), depending on the fire-protection requirements. These tests simulate low-energy ignition sources which occur in electrical devices and to which plastic parts in electrical modules can be exposed.

Surprisingly, it has now been found that salts of phosphinic acids in combination with a number of synergistic compounds prove to be effective flame retardants for thermoset resins, such as unsaturated polyester resins or epoxy resins.

Alkali metal salts of phosphinic acids have previously been proposed as flame-retardant additives for thermoplastic polyesters (DE-A-44 30 932). They have to be added in amounts of up to 30% by weight. The salts of phosphinic acids with an alkali metal or with a metal of the second or third main group of the Periodic Table, in particular the zinc salts (DE-A-2 447 727) have also been used to prepare flame-retardant polyamide molding compositions. There is a marked difference in fire performance between thermoplastic polyesters, such as PET and PBT, and thermosetting polyesters, such as unsaturated polyester resins: in a fire thermoplastic materials produce drops of falling material, but thermosetting materials do not melt or produce drops of falling material.

Specifically, the invention relates to flame-retardant thermoset compositions which comprise, as flame retardant, at least one phosphinic salt of the formula (I) and/or a diphosphinic salt of the formula (II) and/or polymers of these

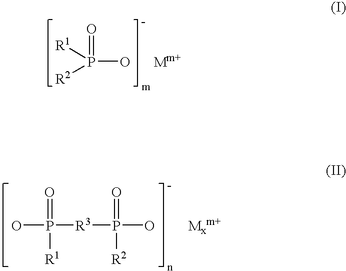

where

R¹,R² are identical or different and are C₁-C₆-alkyl, linear or branched, and/or aryl;

R³ is C₁-C₁₀-alkylene, linear or branched, C₆-C₁₀-arylene, -alkylarylene or -arylalkylene;

M is Mg, Ca, Al, Sb, Sn, Ge, Ti, Zn, Fe, Zr, Ce, Bi, Sr, Mn, Li, Na, K and/or a protonated nitrogen base;

m is from 1 to 4;

n is from 1 to 4; and

x is from 1 to4,

and also comprise at least one synergistic component from the group consisting of organic or inorganic phosphorus compounds.

M is preferably calcium, aluminum or zinc.

Protonated nitrogen bases are preferably the protonated bases of ammonia, melamine, triethanolamine, in particular NH₄⁺.

R¹ and R² are preferably identical or different and are C₁-C₆-alkyl, linear or branched, and/or phenyl.

R¹ and R² are preferably identical or different and are methyl, ethyl, n-propyl, isopropyl, n-butyl, tert-butyl, n-pentyl and/or phenyl.

R³ is preferably methylene, ethylene, n-propylene, isopropylene, n-butylene, tert-butylene, n-pentylene, n-octylene or n-dodecylene.

Other preferred radicals for R³ are phenylene and naphthylene.

Other preferred radicals for R³ are methylphenylene, ethylphenylene, tert-butylphenylene, methylnaphthylene, ethylnaphthylene and tert-butylnaphthylene.

Other preferred radicals for R³ are phenylmethylene, phenylethylene, phenylpropylene and phenylbutylene.

The novel flame-retardant thermoset compositions preferably comprise from 0.1 to 30 parts by weight of at least one phosphinic salt of the formula (I) and/or a diphosphinic salt of the formula (II) and/or polymers of these, and from 0.1 to 100 parts by weight of an organic phosphorus compound, per 100 parts by weight of thermoset composition.

The novel flame-retardant thermoset compositions particularly preferably comprise from 1 to 15 parts by weight of at least one phosphinic salt of the formula (I) and/or a diphosphinic salt of the formula (II) and/or polymers of these, and from 1 to 20 parts by weight of an organic phosphorus compound, per 100 parts by weight of thermoset composition.

The organic phosphorus compound is preferably triethyl phosphate, triaryl phosphates, tetraphenyl resorcinaldiphosphate, dimethyl methylphosphonate, and/or its polymer with phosphorus pentoxide, phosphonate ester, (5-ethyl-2-methyl-dioxaphosphorinan-5-yl)methyl methyl methanephosphonate, phosphoric ester, pyrophosphoric ester, alkylphosphinic acids, and/or oxalkylated derivatives of these.

The flame-retardant thermoset compositions of the invention preferably comprise from 0.1 to 30 parts by weight of at least one phosphinic salt of the formula (I) and/or one diphosphinic salt of the formula (II) and/or polymers of these, and from 0.1 to 100 parts by weight of an inorganic phosphorus compound, per 100 parts by weight of thermoset composition.

The flame-retardant thermoset compositions of the invention particularly preferably comprise from 1 to 15 parts by weight of at least one phosphinic salt of the formula (I) and/or one diphosphinic salt of the formula (II) and/or polymers of these, and from 1 to 20 parts by weight of an inorganic phosphorus compound, per 100 parts by weight of thermoset composition.

The inorganic phosphorus compound is preferably red phosphorus, ammonium phosphate and/or melamine polyphosphate.

The flame-retardant thermoset compositions of the invention preferably also comprise carbodiimides.

The invention further relates to flame-retardant thermoset compositions which are molding compositions, coatings or laminates made from thermoset resins.

The thermoset resins are preferably unsaturated polyester resins or epoxy resins.

The invention further relates to a process for preparing flame-retardant thermoset compositions, which comprises mixing a thermoset resin with a flame retardant made from at least one phosphinic salt of the formula (I) and/or a diphosphinic salt of the formula (II) and/or polymers of these with at least one synergistic component from the group consisting of organic or inorganic phosphorus compounds, and wet-pressing (cold-pressing) the resultant mixture at pressures of from 3 to 10 bar and at temperatures of from 20 to 80° C.

The invention further relates to a process for preparing flame-retardant thermoset compositions, which comprises mixing a thermoset resin with a flame retardant made from at least one phosphinic salt of the formula (I) and/or a diphosphinic salt of the formula (II) and/or polymers of these with at least one synergistic component from the group consisting of organic or inorganic phosphorus compounds, and wet-pressing (warm- or hot-pressing) the resultant mixture at pressures of from 3 to 10 bar and at temperatures of from 80 to 150° C.

Another process for preparing flame-retardant thermoset compositions according to the present invention comprises mixing a thermoset resin with a flame retardant made from at least one phosphinic salt of the formula (I) and/or a diphosphinic salt of the formula (II) and/or polymers of these with at least one synergistic component from the group consisting of organic or inorganic phosphorus compounds, and processing the resultant mixture at pressures of from 50 to 150 bar and at temperatures of from 140 to 160° C to give prepregs.

Finally, the invention also relates to the use of the novel flame-retardant combination for rendering thermoset compositions flame-retardant.

The thermoset compositions are preferably unsaturated polyester resins or epoxy resins, and are preferably molding compositions, coatings or laminates.

The salts of the phosphinic acids, as used according to the invention, may be prepared by known methods as described in more detail, for example, in EP-A-0 699 708.

As set out in the examples below, it has been shown that when organic or inorganic phosphorus compounds, such as ammonium polyphosphate, and phosphinic salts of the formula (I) and, respectively, (II) are tested by themselves they have insufficient activity in thermoset resins.

Surprisingly, it has now been found that a combination of phosphinic salts and organic or inorganic phosphorus compounds is suitable for achieving the best material classification, V-0, in the UL 94 vertical test in thermosets. The compounds used in the examples are as follows:

®Alpolit SUP 403 BMT (Vianova Resins GmbH, Wiesbaden, Germany): unsaturated polyester resin, about 57% strength in styrene, acid number not more than 30 mg KOH/g, preaccelerated and formulated to be slightly thixotropic, low viscosity (viscosity from a 4 mm flow cup: 110±10 s) and greatly reduced styrene emission.

®Palatal 340 S (DSM-BASF Structural Resins, Ludwigshafen, Germany): unsaturated polyester resin, about 49% strength in styrene and methyl methacrylate, density 1.08 g/ml, acid number 7 mg KOH/g, preaccelerated, low viscosity (dynamic viscosity about 50 mPa*s).

®Beckopox EP 140 (Vianova Resins GmbH, Wiesbaden, Germany): low-molecular-weight condensation product from bisphenol A and epichlorohydrin with a density of 1.16 g/ml and an epoxy equivalent of from 180 to 192

®Beckopox EH 625 (Vianova Resins GmbH, Wiesbaden, Germany): modified aliphatic polyamine with an active hydrogen equivalent weight of 73 and a dynamic viscosity of about 1000 mPa*s.

Cobalt accelerator NL 49P (Akzo Chemie GmbH, Düren, Germany): cobalt octoate solution in dibutyl phthalate with a cobalt content of 1% by weight.

Cobalt accelerator NL 63-10S (Akzo Chemie GmbH, Düren, Germany).

Butanox M 50 (Akzo Chemie GmbH, Düren, Germany): methyl ethyl ketone peroxide phlegmatized with dimethyl phthalate—clear liquid with a content of at least 9% by weight of active oxygen.

DEPAL: aluminum salt of diethylphosphinic acid.

Preparation of Test Specimens

The thermoset resin and the flame retardant components, and also, if desired, other additives are mixed homogeneously using a dissolver disk. Homogenization is repeated after adding the curing agent.

In the case of unsaturated polyester resins, the resin is mixed with the cobalt accelerator, the flame retardant components are added and the curing is initiated by adding the peroxide after homogenization.

In the case of epoxy resins, the flame retardant components are added to the epoxy resin component and mixed homogeneously. The amine hardener or, respectively, the anhydride hardener is then added.

Two layers of continuous-strand glass-fiber mat of 450 g/m² weight per unit area, on a ®Hostaphan release film and a steel frame, are placed in a heated press. About half of the resin-flame-retardant mixture is then uniformly distributed. Another glass mat is then added and then the remaining resin-flame-retardant mixture is distributed, the laminate is covered with a release film and a pressed sheet of 4 mm thickness is produced at a temperature of 50° C. during a period of one hour at a pressure of 10 bar.

The fire performance testing was carried out according to the Underwriters Laboratories “Test for Flammability of Plastics Materials—UL 94” specification, in the May 2, 1975 edition, using specimens of length 127 mm, width 12.7 mm and various thicknesses.

The determination of oxygen index was based on ASTM D 2863-74, using a modified apparatus.

Results with Unsaturated Polyester Resins

Table 1 shows comparative examples with use, on their own and in combination, of organic or inorganic phosphorus compounds and DEPAL as flame retardants for an unsaturated polyester resin (Viapal UP 403 BMT). It can be seen from the table that the use, on their own, of phosphorus compounds at concentrations of 25 parts per 100 parts of unsaturated polyester resin cannot achieve V-0 classification.

However, a V-0 classification can be achieved using the combination of DEPAL with phosphorus compounds, at a laminate thickness of 1.5 mm. The laminates may be colored as desired.

These UP resin laminates can be produced by the injection process, because the filler content is low.

### TABLE 1 COMPARATIVE EXAMPLES

Fire performance of unsaturated polyester resin laminates to UL 94, 30% by weight of continuous-strand glass-fiber mat, laminate thickness 1.5 mm, Viapal UP 403 BMT resin, Butanox M50 hardener, NL 49 P accelerator

| Example | Parts of flame | UL 94 | |
|---|---|---|---|
| No. | retardant/100 parts resin | classification | LOI |
| 1 | 25 DEPAL* | n.c. | 0.33 |
| 2 | 25 triethyl phosphate | n.c. | 0.28 |
| 3 | 25 melamine polyphosphate | n.c. | 0.30 |
| 4 | 10 DEPAL + 10 triethyl phosphate | V-0 | 0.38 |
| invention | | | |
| 5 | 10 DEPAL + 10 melamine | V-0 | 0.42 |
| invention | polyphosphate | | |

**DEPAL = aluminum diethylphosphinate
n.c. = not classifiable in the vertical UL 94 test

Results with Epoxy Resins

Table 2 shows fire tests using a polyamine-cured epoxy resin (Beckopox EP 140 resin, Beckopox EH 625 hardener). By combining DEPAL with phosphorus compounds, however, a V-0 classification can be achieved at a laminate thickness of 1.5 mm. Using the compounds alone, in contrast, UL 94 V-0 is not achieved using 25 parts of flame-retardant.

### TABLE 2

Fire performance of epoxy resin moldings to UV 94, material thickness 1.6 mm, resin 100 parts of Becopox EP 140, hardener 39 parts of Beckopox EH 625

| Example | Parts of flame | UL 94 | |
|---|---|---|---|
| No. | retardant/100 parts resin | classification | LOI |
| 6 | 10 DEPAL | n.c. | 0.27 |
| 7 | 20 DEPAL | V-1 | 0.32 |
| 8 | 25 triethyl phosphate | n.c. | 0.25 |
| 9 | 25 melamine polyphosphate | V-1 | 0.39 |
| 10 | 10 DEPAL + 10 triethyl phosphate | V-0 | 0.41 |
| invention | | | |
| 11 | 10 DEPAL + 10 melamine | V-0 | 0.40 |
| invention | polyphosphate | | |

1. A flame-retardant thermoset composition which comprises, as flame retardant, at least one phosphinic salt of the formula (I) and/or a diphosphinic salt of the formula (II) and/or polymers of these 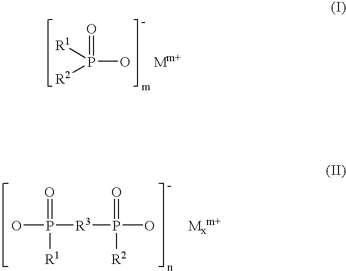
where
R¹,R² are identical or different and are C₁-C₆-alkyl, linear or branched, and/or aryl;
R³ is C₁-C₁₀-alkylene, linear or branched, C₆-C₁₀-arylene, -alkylarylene or -arylalkylene;
M is Mg, Ca, Al, Sb, Sn, Ge, Ti, Zn, Fe, Zr, Ce, Bi, Sr, Mn, Li, Na, K and/or a protonated nitrogen base;
m is from 1 to 4;
n is from 1 to 4; and
x is from 1 to 4,
and also comprise at least one synergistic component from the group consisting of organic or inorganic phosphorus compounds.

2. A flame-retardant thermoset composition as claimed in claim 1, wherein R¹ and R² are identical or different and are C₁-C₆-alkyl, linear or branched, and/or phenyl.

3. A flame-retardant thermoset composition as claimed in claim 1 or 2, wherein R¹ and R² are identical or different and are methyl, ethyl, n-propyl, isopropyl, n-butyl, tert-butyl, n-pentyl and/or phenyl.

4. A flame-retardant thermoset composition as claimed in one or more of claims 1 to 3, wherein R³ is methylene, ethylene, n-propylene, isopropylene, n-butylene, tert-butylene, n-pentylene, n-octylene or n-dodecylene.

5. A flame-retardant thermoset composition as claimed in one or more of claims 1 to 3, wherein R³ is phenylene or naphthylene.

6. A flame-retardant thermoset composition as claimed in one or more of claims 1 to 3, wherein R³ is methylphenylene, ethylphenylene, tert-butyl-phenylene, methylnaphthylene, ethylnaphthylene or tert-butylnaphthylene.

7. A flame-retardant thermoset composition as claimed in one or more of claims 1 to 3, wherein R³ is phenylmethylene, phenylethylene, phenyl-propylene or phenylbutylene.

8. A flame-retardant thermoset composition as claimed in one or more of claims 1 to 7, which comprises from 0.1 to 30 parts by weight of phosphinic salt of the formula (I) and/or a diphosphinic salt of the formula (II) and/or polymers of these, and from 0.1 to 100 parts by weight of an organic phosphorus compound, per 100 parts by weight of thermoset composition.

9. A flame-retardant thermoset composition as claimed in one or more of claims 1 to 7, which comprises from 1 to 15 parts by weight of phosphinic salt of the formula (I) and/or a diphosphinic salt of the formula (II) and/or polymers of these, and from 1 to 20 parts by weight of an organic phosphorus compound, per 100 parts by weight of thermoset composition.

10. A flame-retardant thermoset composition as claimed in one or more of claims 1 to 7, wherein the organic phosphorus compound is triethyl phosphate, triaryl phosphates, tetraphenyl resorcinaldiphosphate, diemthyl methylphosphonate, and/or its polymer with phosphorus pentoxide, phosphonate ester, (5-ethyl-2-methyl-dioxaphosphorinan-5-yl)methyl methyl methanephosphonate, phosphoric acid, pyrophosphoric ester, alkylphosphonic acids, and/or oxalkylated derivatives of these.

11. A flame-retardant thermoset composition as claimed in one or more of claims 1 to 7, comprising from 0.1 to 30 parts by weight of phosphinic salt of the formula (I) and/or a diphosphinic salt of the formula (II) and/or polymers of these and from 0.1 to 100 parts by weight of an inorganic phosphorus compound, per 100 parts by weight of thermoset composition.

12. A flame-retardant thermoset composition as claimed in one or more of claims 1 to 7, comprising from 1 to 15 parts by weight of phosphinic salt of the formula (I) and/or a diphosphinic salt of the formula (II) and/or polymers of these, and from 1 to 20 parts by weight of an inorganic phosphorus compound, per 100 parts by weight of thermoset composition.

13. A flame-retardant thermoset composition as claimed in one or more of claims 1 to 7, wherein the inorganic phosphorus compound is red phosphorus, ammonium phosphate, and/or melamine polyphosphate.

14. A flame-retardant thermoset composition as claimed in one or more of claims 1 to 13, which also comprises carbodiimides.

15. A flame-retardant thermoset composition as claimed in one or more of claims 1 to 14, which is a molding composition, a coating or a laminate made from thermoset resins.

16. A flame-retardant thermoset composition as claimed in claim 15, wherein the thermoset resins are unsaturated polyester resins or epoxy resins.

17. A process for preparing flame-retardant thermoset compositions as claimed in one or more of claims 1 to 16, which comprises mixing a thermoset resin with a flame retardant made from phosphinic salt of the formula (I) and/or a diphosphinic salt of the formula (II) and/or polymers of these with at least one synergistic component from the group consisting of organic or inorganic phosphorus compounds, and wet-pressing (cold-pressing) the resultant mixture at pressures of from 3 to 10 bar and at temperatures of from 20 to 60° C.

18. The process for preparing flame-retardant thermoset compositions as claimed in one or more of claims 1 to 16, which comprises mixing a thermoset resin with a flame retardant made from phosphinic salt of the formula (I) and/or a diphosphinic salt of the formula (II) and/or polymers of these with at least one synergistic component from the group consisting of organic or inorganic phosphorus compounds, and wet-pressing (warm- or hot-pressing) the resultant mixture at pressures of from 3 to 10 bar and at temperatures of from 80 to 150° C.

19. The process for preparing flame-retardant thermoset compositions as claimed in one or more of claims 1 to 16, which comprises mixing a thermoset resin with a flame retardant made from phosphinic salt of the formula (I) and/or a diphosphinic salt of the formula (II) and/or polymers of these with at least one synergistic component from the group consisting of organic or inorganic phosphorus compounds, and processing the resultant mixture at pressures of from 50 to 150 bar and at temperatures of from 140 to 160° C. to give prepregs.
